(19) United States
(12) Patent Application Publication
(10) Pub. No.: US 2005/0120237 A1
(43) Pub. Date: Jun. 2, 2005

(54) Control of processes in a processing system

(76) Inventors: Peter Terence Roux, (US); Monika Dongare, (US)

Correspondence Address: BAKER & HOSTETLER LLP, Washington Square, Suite 1100, 1050 Connecticut Avenue, N.W., WASHINGTON, DC, 20036, US

(21) Appl. No.: 10/831,162

(22) Filed: Apr. 26, 2004

(30) Foreign Application Priority Data
Dec. 10, 2001 (GB) 0129539.3
Oct. 26, 2001 (GB) 0125756.7

(51) Int. Cl. H04L 9/00

(52) U.S. Cl. 713/200

(57) ABSTRACT

A method and system for controlling processes executed by one or more processors in a processing system comprises identifying any processes being executed by the or each processor, comparing any identified processes with stored information on one or more processes, and controlling the execution of the processes by the or each processor in dependence upon the outcome of the comparison. A user interface is generated in dependence upon the results of the comparison to allow for manual override control of the execution of a process.

The present invention generally relates to the control of processes in a processing system such as a multi-tasking processing system capable of executing more than one process at the same time by reference to stored information on known processors. Such systems can comprise a computer, or a mobile device such as a personal digital assistant (PDA).

It is desirable in processing systems to control the processes which can be executed. In a multi-tasking processing system such as that operated by modern computers implementing multi-tasking operating systems such as Windows 95, Windows 98, Windows 2000, Windows XP (Windows is a trade mark of Microsoft Corp.), Linux (trade mark) and Apple (trade mark) operating systems. Many different and independent processes can be executed simultaneously.

One prior art system for controlling processes operated within a multi-tasking operating system is the SecureEXE product from Securewave (www.securewave.com). This product provides for central network management of processes implemented by computers within a network. The database of authorized applications is stored centrally and a central management interface is provided to allow a network manager to authorize processes to be implemented within the network. A driver on a client in a network detects an attempt to run a program. A signature for the program is calculated using a hashing technique and this is compared with hashes for a list of allowed programs downloaded from the server. If a match is not found, the driver will prohibit the attempt to load the program. Thus this system requires a hashing technique to be used and requires central management of process control. A local user is not provided with any ability to manually override the automatic decision taken by the driver in the client computer.

A first aspect of the present invention provides a method and system for controlling the processes executed by one or more processors in a processing system in which information on one or more processes is stored. Any processes being executed by the or each processor are identified and compared with the stored information. A user interface is generated in dependence upon the comparison to allow a user to select to allow or disallow the process. The execution of the processes by the or each processor is then controlled in dependence upon the outcome of the comparison and the user selection.

The present invention can be used in any processing system that can execute one or more processes and a particular utility in the field of multi-tasking processing systems.

Thus in accordance with this aspect of the present invention, information on allowed or disallowed processes can be stored to thereby control the processing of those processes and a manual override capability is provided to allow some user control. This facility allows a user to select to allow desirable new processes to run, e.g. a new application and to select to disallow undesirable new processes to run, e.g. trojans and viruses.

In a preferred embodiment of the present invention, the processing system executes a multi-tasking operating system which maintains a process list containing a list of processes currently being executed by the or each processor. The processes being executed by the or each processor are thus identified using the process list.

In one embodiment, in order to provide continuous monitoring of control, the process identification, comparison, and control is carried out repeatedly. The periodicity of repetition of the process identification, comparison, and control can be selectable e.g. by a user.

In one embodiment of the present invention, the method is preferably implemented by executing processor code in the processing system during a boot-up procedure of the processing system. During the boot-up procedure, the processes being executed by the or each processor can be identified and stored as the stored information. In this way, since the processing code of the controlling application is implemented on boot-up, i.e. when the machine is starting-up and before a user can select to execute applications, if there is no stored information on processes, i.e. the control application is being executed for the first time, the processes being executed by the or each processor can be identified and stored as an initial set of stored information.

In one embodiment, the stored information on processes comprises information obtained from user input selections identifying processes to be allowed and/or disallowed.

As a security measure, to prevent the controlling process being disabled, in one embodiment the control process is hidden and is not included in the identified processes, e.g. it is not in the process list. In one embodiment this can be achieved by implementing the control process as a service. In an alternative embodiment, this can be achieved by deleting the process from the process list, thereby hiding the control process.

The control of the processes can either allow the process to be executed, or the processing of a process can be halted. In one embodiment the information stored on the processors identifies processes that are to be allowed to be executed. Any processes which are identified as not being allowed to be executed during the comparison step are halted. In another embodiment of the present invention, the information on the processors can identify processes which are disallowed. Thus the execution of only those processes identified by the comparison step as being disallowed is halted.

In one embodiment of the present invention, the stored information contains information on processes which are allowed to be executed. If it is determined from the comparison that there are processes which are not identified as being allowed, the user interface is generated to allow a user to input a user selection to allow or disallow the execution of the identified process. The execution of the process is then controlled in dependence upon the input user selection. In a preferred embodiment, the stored information also includes information on one or more processes which are not allowed to be executed. If the comparison identifies processes which are not allowed to be executed, the processes are halted without generating the user interface for any such process which is identified as not being allowed to be executed. Thus in this embodiment, a user can select to allow or disallow an unknown process, i.e. a process which is not identified in the list of disallowed or allowed processes while allowed processes are allowed to be executed automatically and disallowed processes are halted automatically. The user selections can be used to modify stored information so that in future a process previously known is included in the allowed or disallowed list dependent upon the user selection. This modification of the stored information can be user selectable.

In another embodiment of the present invention, the stored information identifies processes not to be allowed to be executed. As a result of the comparison and identification of a disallowed process, the user interface is generated indicating that the process is disallowed thereby allowing a user to input a user selection to allow or disallow execution of the identified process. The execution of the identified process is thus controlled in dependence upon the user selection. In this embodiment of the present invention, the stored information can also include information on processes to be allowed to be executed. If the comparison identifies any such allowed process, the execution of the process is controlled to allow the process to be executed automatically.

In another embodiment of the present invention, the stored information includes information on processes not to be allowed to be executed. If as a result of the comparison it is to determined that there is an identified process that is not allowed to be executed, the execution of the process is controlled by halting the process and the user interface is generated to allow a user to input a use selection to allow or disallow the execution of the identified process next time. The stored information is then updated as necessary as a result of the input user selection, e.g. if the user selects to allow the process next time, the process is added into the list of allowed processes. In this embodiment of the present invention, the stored information can also include information on processes which are allowed to be executed. As a result of the comparison, if any such process is identified, the execution of the process is controlled to allow the process to be executed automatically.

In one embodiment of the present invention, the stored information includes information on when at least one of the processes is allowed or disallowed to be executed and the comparison of any identified processes with the stored information includes determining the current date and/or time for use in the comparison with said stored information. Thus this embodiment of the present invention allows the processing system to be controlled to allow or disallow processes from being executed at certain times such as times of the day, days of the week, or dates. For example, the stored information can store a start time/day/date and an end time/day/date during which a process is to be allowed or disallowed from executing.

In another embodiment of the present invention, the stored information includes information on the number of times a process has been executed and information on the number of times a process is allowed to be executed and the comparison of any identified processes with the stored information includes comparing the information on the number of times the process is allowed to be executed with the information on the number of times the process has executed. The user interface is generated if the number of times a process has been executed equals the number of times the process is allowed to be executed to allow a user to input a user selection to allow or disallow the execution of the process, and the information on the number of times the process has been executed in said stored information is updated if the process is allowed to be executed. Thus in this embodiment, a process can be set to only be allowed to be executes for a limited number of times.

In another embodiment of the present invention, the processing system is connected by a communications network to management processing apparatus. Thus this embodiment is applicable to computer networks. The stored information on one or more processes is stored at the management processing apparatus. The managing processing apparatus can be used by a network manage or administrator to allow the stored information to be managed centrally for a number of networked processing apparatuses. The stored information at the management processing apparatus is accessed and read by the processing system over the communications network. In a specific embodiment, the stored information includes identifiers for the or each process to identify whether the process can be allowed or disallowed by an input from a user of the processing system or whether the process can only be allowed or disallowed by an input from an operator of the management processing system. Thus in this embodiment the network administrator can access and configure the stored information to limit the extent of the local user control over the processes. In other words, the manual over ride control that local users have for types of processes can be controlled by the network administrator. In one embodiment, the identifiers can effectively disable the local users ability to over ride the automatic control of a process by controlling the generation of the user interface defendant upon the identifier for the process in said stored information. Thus, if the network administrator has set the identifier for a process to indicate that if the process is disallowed, it cannot be allowed by a local user, no user interface is generated that allows a user to allow the process to be executed.

In a further embodiment of the present invention, information on processes being executed is determined and the information is stored. This information can be used to monitor the execution of processes by a processing system. The determination of information on processes can take place when it is determined that there is a change in the processes being executed. To provide for central management e.g. by a network administrator, the information can be transmitted to a management processing system

In one embodiment of the present invention, the information stored for each process can comprise at least one of file name and path, file size version number, and date of creation of the application file for which the process is an instance. The comparison can thereby be carried out using any number of these parameters to compare an identified process being executed by the or each processor, and the stored information on the processes.

The present invention is useful for the management of processes implemented in a processing system. For example, a control application can be loaded onto computers in a computer network and the stored information can be set up by a network manager or administrator to thereby control the process which can be implemented on each of the networked computers. Alternatively, or in addition, the present invention is particularly useful as a trojan or virus protection method since it will automatically identify unknown processes. Unknown processes can be controlled by halting the process or allowing a user an opportunity to allow the execution of the process. To ensure that known trojans and viruses are not executed, these can be added into the list of disallowed processes in the stored information to ensure that the execution of such processes is halted or terminated as soon as they are detected or identified. The present invention can thus be implemented on any type of multi-tasking processing system including computers (networked or stand-alone) and mobile devices (such as PDAs). The invention does not require central management and provides the user with an ability to utilize the automatic process detection whilst being able to manually override when desired. Central network management can be provided to control the level of process control given to local users.

Another aspect of the present invention provides a method and system for controlling any process executed by at least one processor in a processing system which operates under the control of an operating system. Any process being executed by the or each processor is identified using a process list which is maintained by the operating system and which contains a list of currently executed processes. Any identified process is compared with stored information on one or more processes. The execution of the identified processes by the or each processor is then controlled in dependence upon the outcome of the comparison.

Another aspect of the present invention provides a method and system for controlling at least one process executed by at least one processor in a processing system in which information on processes to be allowed to be executed by the or each processor is stored. Processes being executed by the or each processor are identified and compared with the stored information to determine if there are any identified processes which are not identified as being allowed to be executed. If it is determined that there is an identified process which is not identified as being allowed to be executed, a user interface is generated to allow a use to input a user selection to allow or disallow the execution of the identified process. The execution of the process is then controlled in dependence upon the user selection.

Another aspect of the present invention provides a method and system for controlling at least one process executed by at least one processor in a processing system in which information on processes not to be allowed to be executed by the or each processor is stored. Processes being executed by the or each processor are identified and compared with the stored information to detente if there are any identified processes which are identified as not being allowed to be executed. If it is determined that there is an identified process that is identified as not being allowed to be executed, a user interface is generated to allow a user to input a use selection to allow or disallow the execution of the identified process. The execution of the process by the or each processor is then controlled in dependence upon the input user selection.

A further aspect of the present invention provides a method and system for controlling at least one process executed by at least one processor in a processing system in which information on processes not to be allowed to be executed by the or each processor is stored. Processes being executed by the or each processor are identified and compared with the stored information to determine if there are any identified processes that are identified as not being allowed to be executed. If it is determined that there is an identified process that is identified as not being allowed to be executed, the execution of the process is halted and a user interface is generated to allow a user to input a user selection to allow or disallow the execution of the identified process next time. Information identifying the process to be allowed to be executed is added to the information store if the input user selection is to allow the process next time.

All of the aspects of the present invention can be implemented as computer code loaded onto a processing system e.g. a computer, PDA, mobile phone, etc. The present invention thus encompasses computer code provided to a processing system on any suitable carrier medium. The carrier medium encompassed within the present invention can comprise any conventional carrier medium such as a transient carrier medium, e.g. an electrical, optical, microwave, radio frequency, acoustic, or digital signal (e.g. a TCP/IP signal carrying computer code over an IP network such as the Internet), or a storage medium such as a floppy disk, hard disk, CD-ROM, tape device, or sold state memory device.

Embodiments of the present invention will now be described with reference to the accompanying drawings in which:

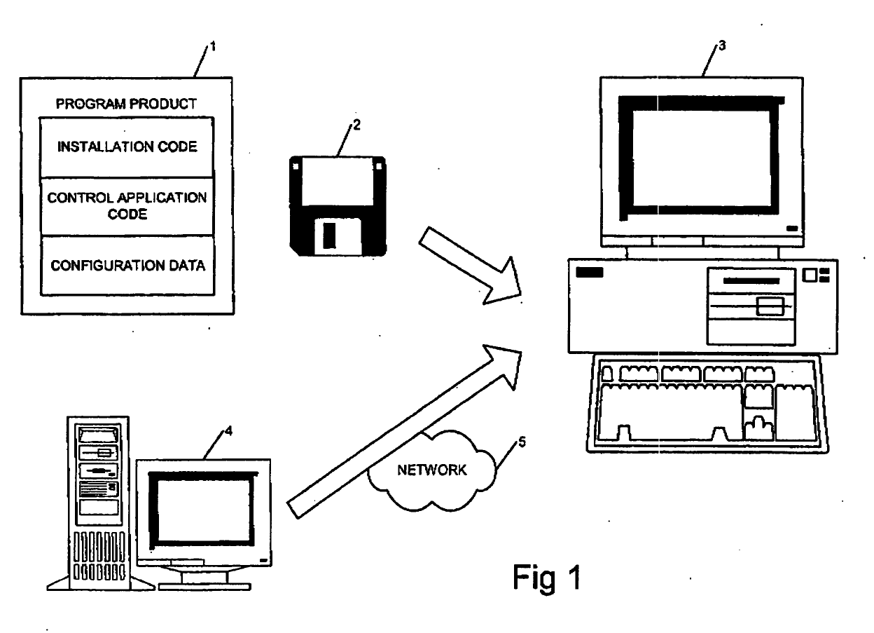

FIG. 1 is a schematic diagram of a system in accordance with the present invention illustrating how the system is initially configured by the loading of software onto a computer;

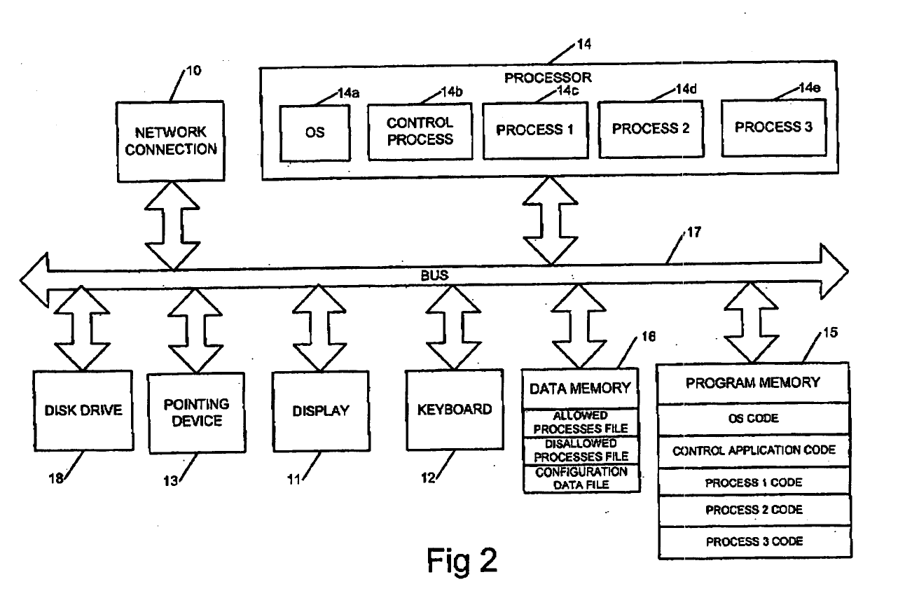

FIG. 2 is a schematic diagram of the architecture of the computer after the installation of the control application code;

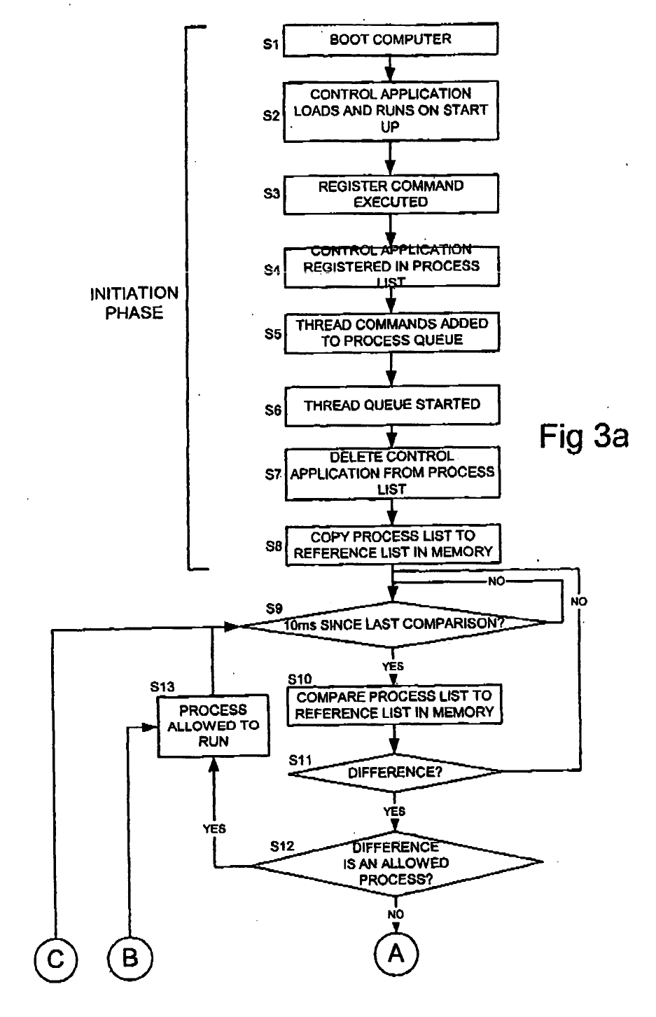

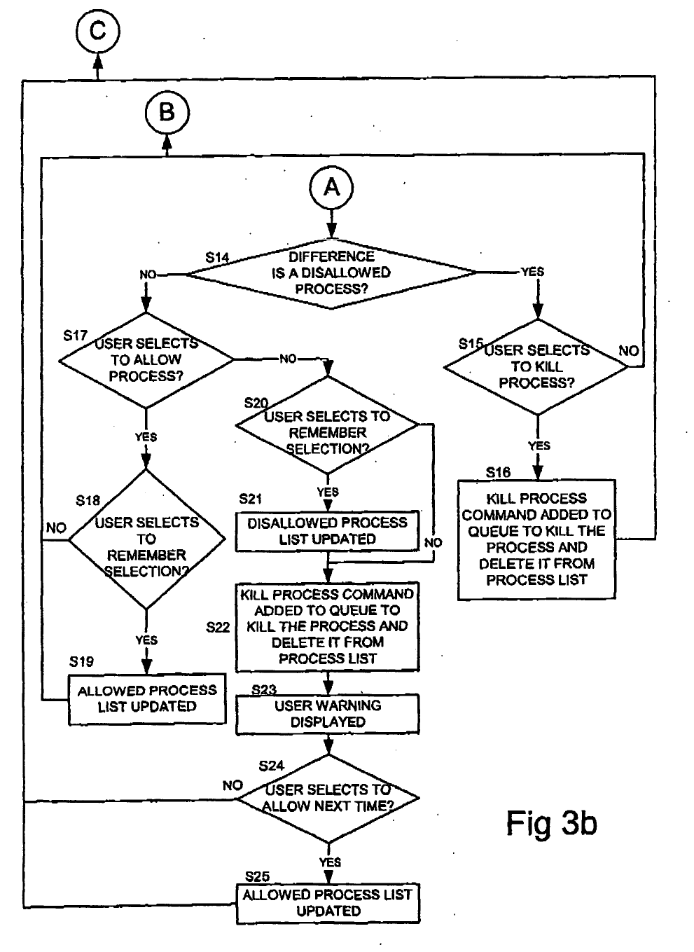

FIG. 3a and 3b are flow diagrams illustrating the operation of the control process in accordance with an embodiment of the invention;

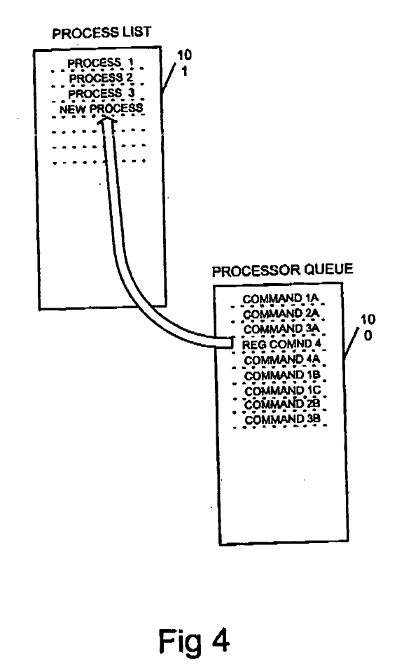

FIG. 4 is a diagram illustrating the interrelationship of the processor queue and the process list managed by the operating system;

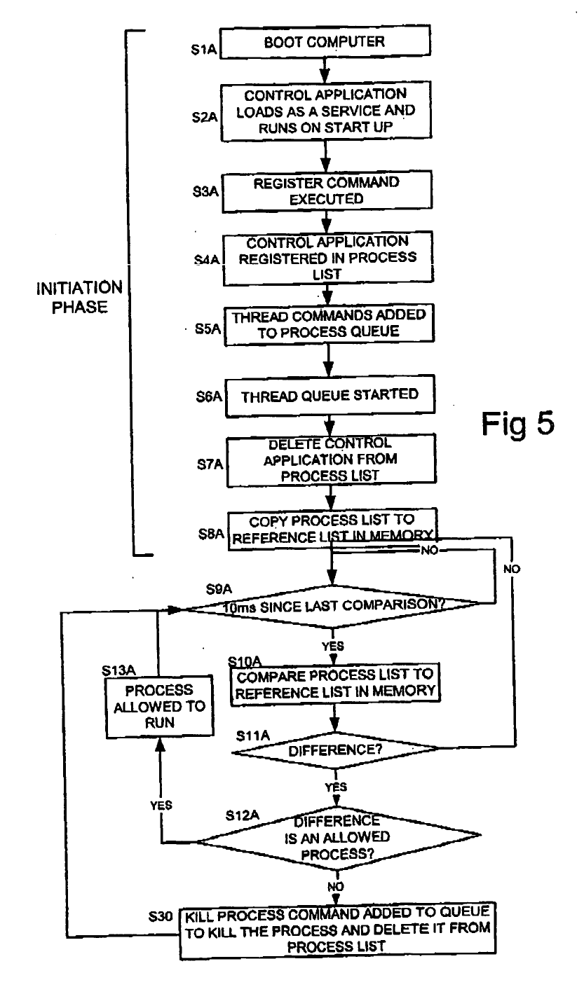

FIG. 5 is a flow diagram illustrating the implementation of the control process in accordance with a second embodiment of the present invention;

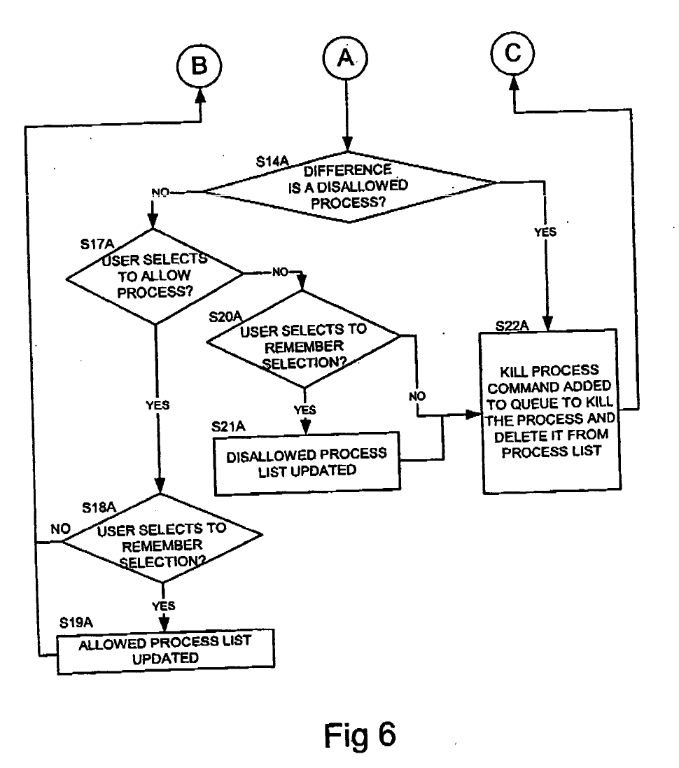

FIG. 6 is a partial flow diagram continuing from FIG. 3a showing the implementation of the control process in accordance with a third embodiment of the present invention;

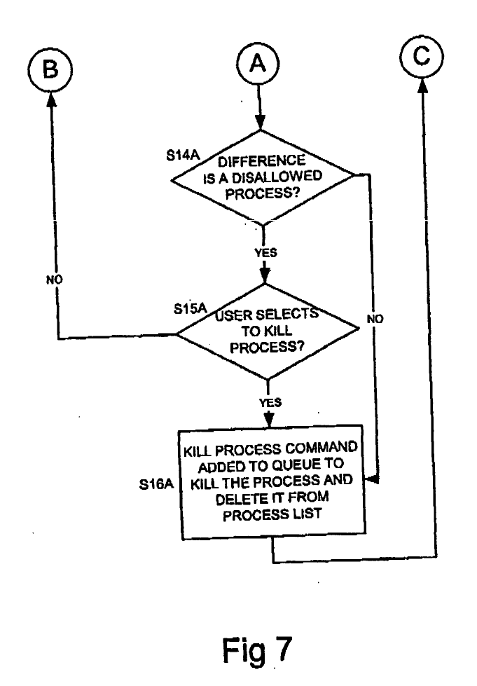

FIG. 7 is a partial flow diagram following on from FIG. 3a showing the execution of the control process in accordance with a fourth embodiment of the present invention;

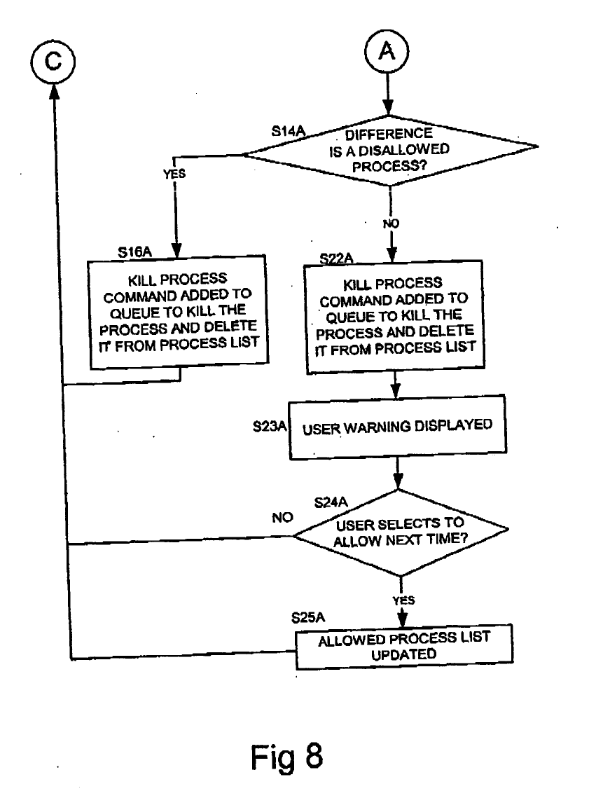

FIG. 8 is a partial flow diagram following on from FIG. 3a showing the execution of the control process in accordance with a fifth embodiment of the present invention;

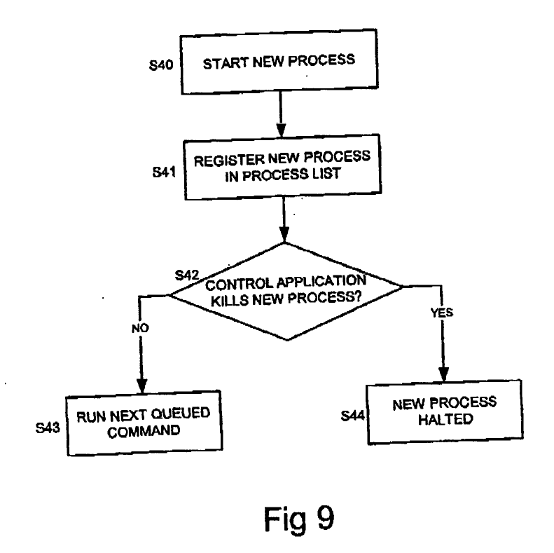

FIG. 9 is a flow diagram illustrating the control of a process in accordance with an embodiment of the present invention;

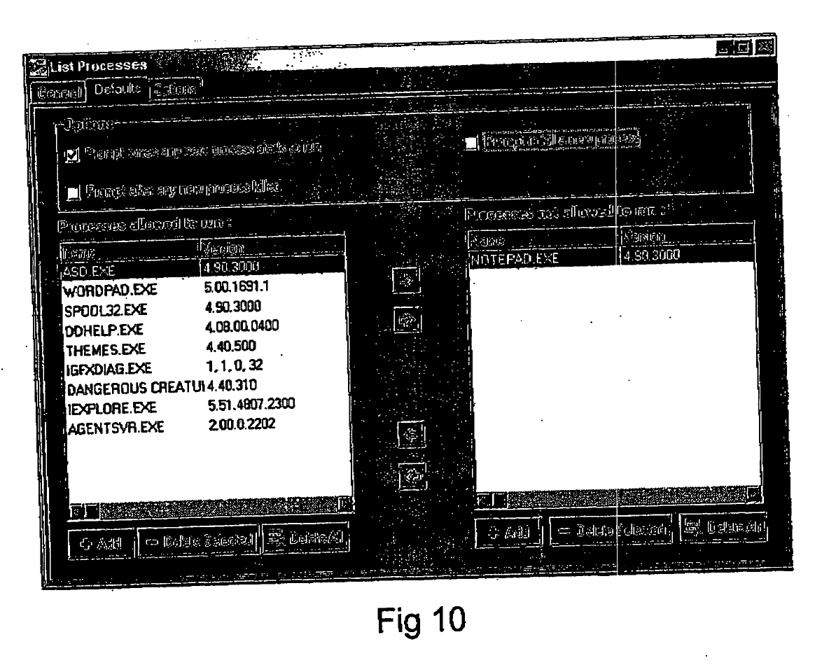

FIG. 10 is a diagram of the user interface in accordance with an embodiment of the present invention in which the control process is configured by user selection to implement the embodiment of the present invention;

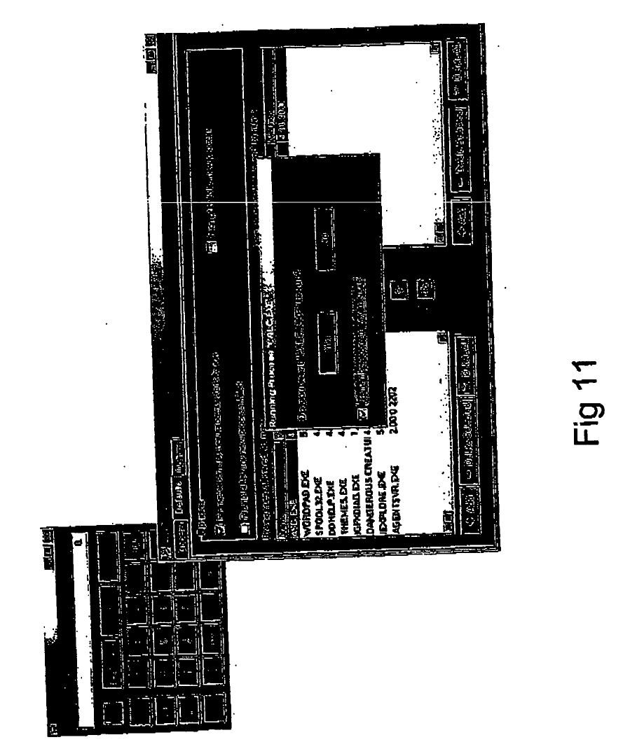

FIG. 11 is a diagram of a user interface generated as a result of the implementation of the control process in accordance with the third embodiment of the present invention to allow a user to select to allow a process;

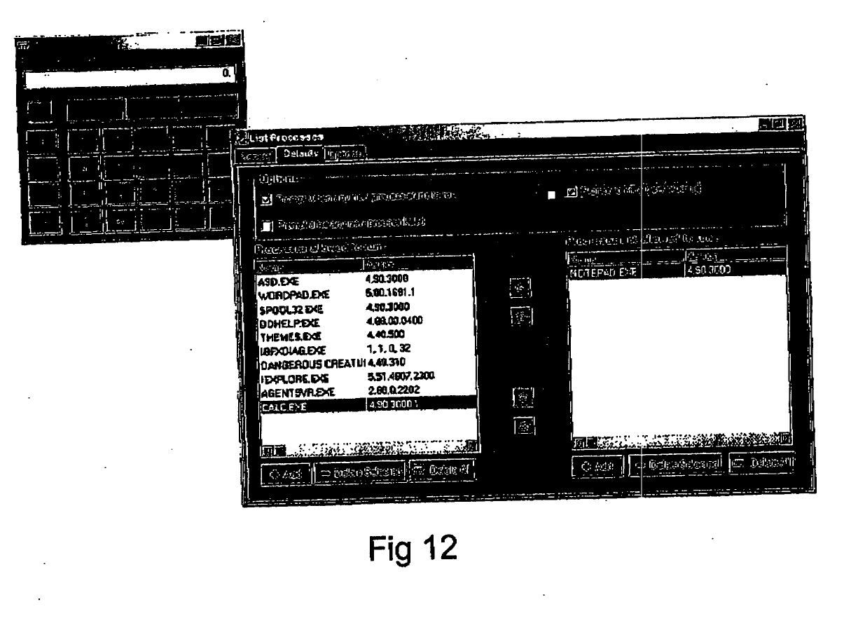

FIG. 12 is a diagram of the user interface illustrating the addition of a process to the allowed list as a result of the user selection in accordance with the third embodiment of the present invention;

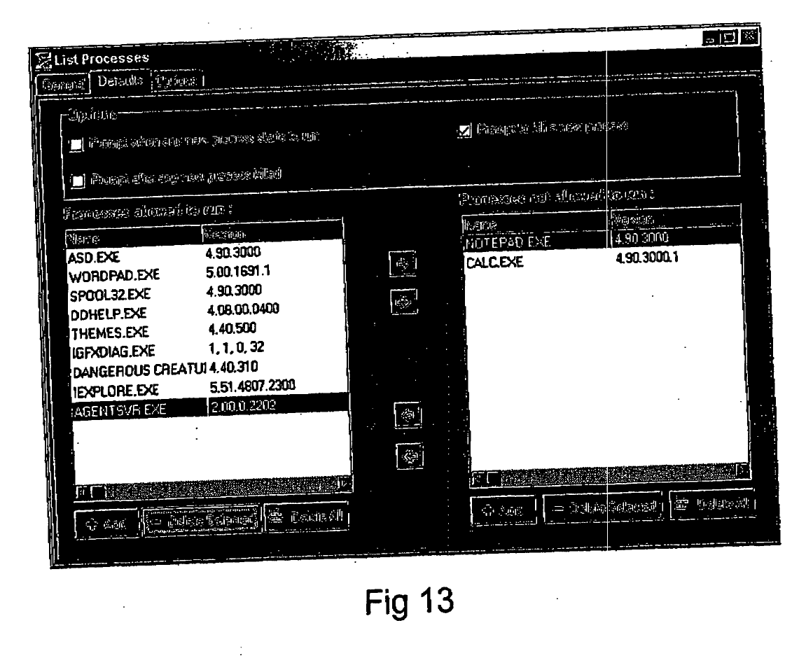

FIG. 13 is a diagram of the user interface in which a user has selected to implement the control process in accordance with the fourth embodiment of the present invention;

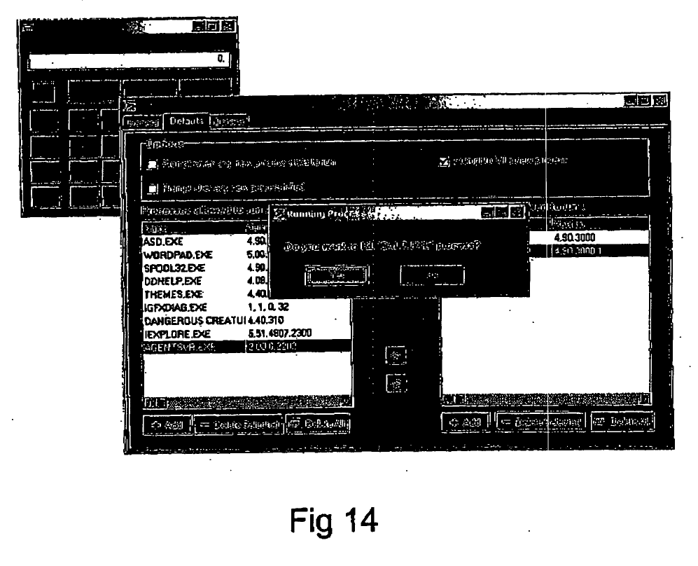

FIG. 14 is a diagram of the user interface generated as a result of the control process implemented in accordance with the fourth embodiment of the present invention to allow a user to select to kill a process which is in the disallowed list;

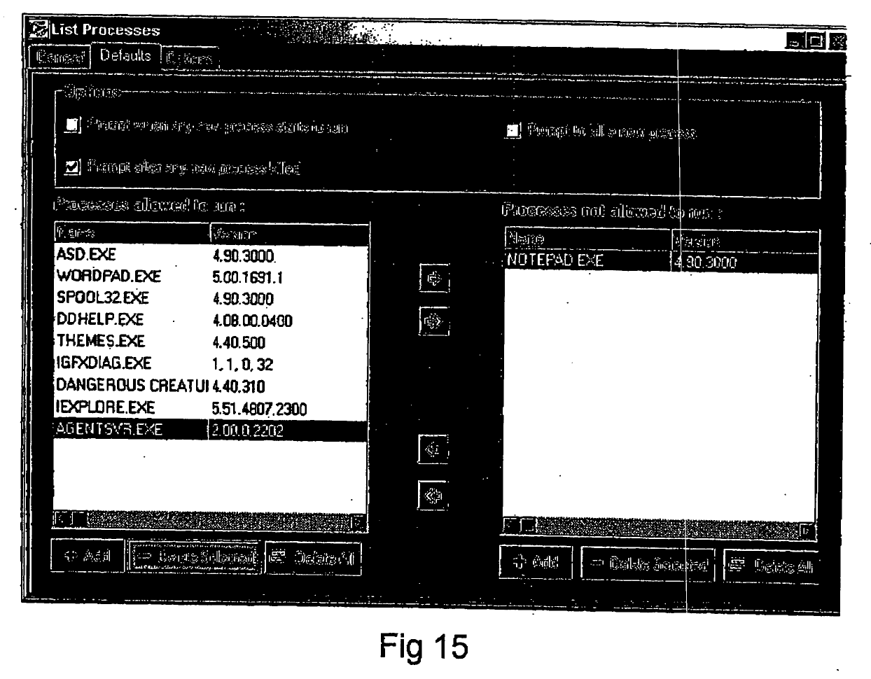

FIG. 15 is a diagram of the user interface in which a user has selected to implement the control process in accordance with the fifth embodiment of the present invention;

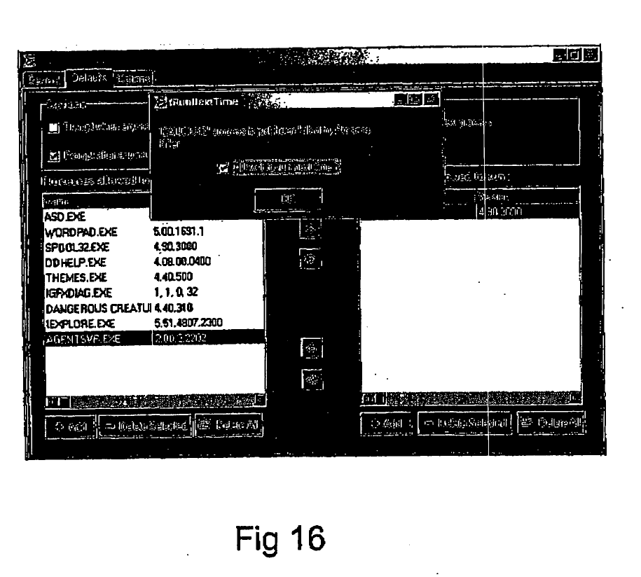

FIG. 16 is a diagram of the user interface generated as a result of the implementation of the control process in accordance with the fifth embodiment of the present invention in which a warning is displayed that a process has been killed and a user is allowed to select to allow the process next time;

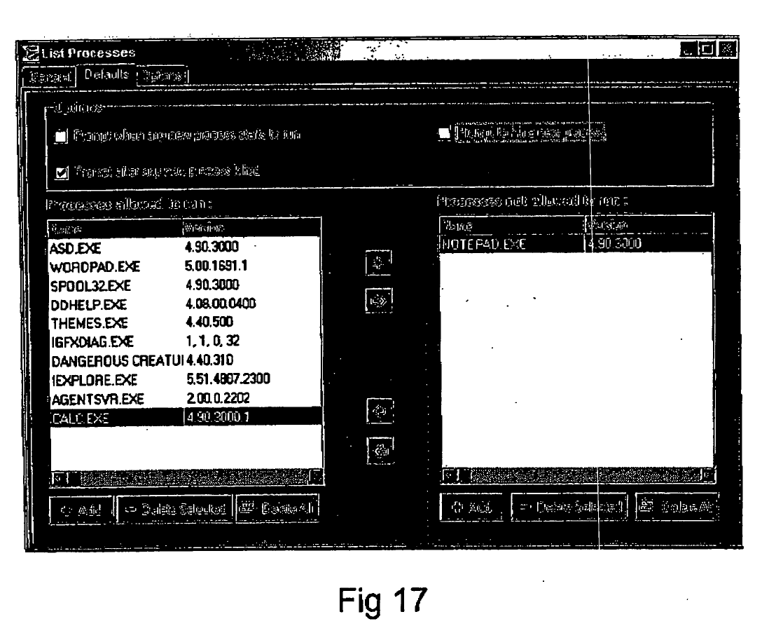

FIG. 17 is a diagram of the user interface showing the addition of the process to the allowed list to allow the process to execute next time in accordance with the fifth embodiment of the present invention;

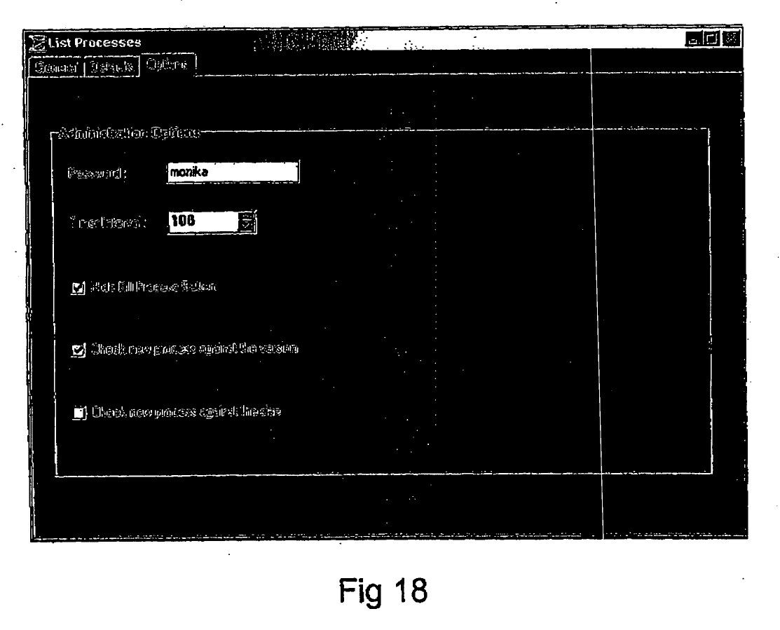

FIG. 18 is a diagram of the user interface available for consideration of the control process in accordance with an embodiment of the present invention; and

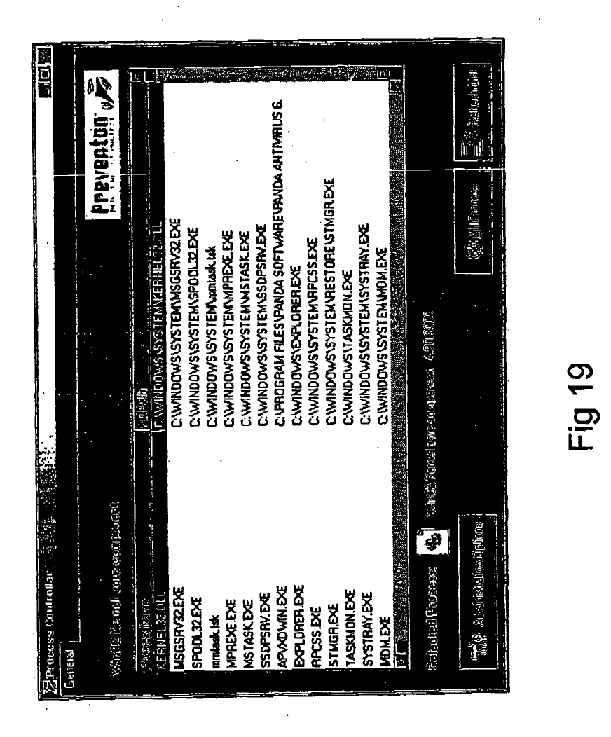

FIG. 19 is a diagram of the user interface illustrating the processes currently being executed by the processor in accordance with an embodiment of the present invention.

FIG. 1 is a schematic diagram illustrating how a computer 3 can be configured to implement the control process in accordance with an embodiment of the present invention. A computer program product 1 which comprises computer code formed of an installation code module, control application code, and configuration data is provided to the computer 3 to be installed therein for the execution of the control application code using the configuration data. The computer program product 1 can be provided to the computer 3 using any conventional carrier medium such as a floppy disk 2, or a signal carried over a network 5 from another computer 4. Although FIG. 1 a floppy disk is illustrated as a suitable storage medium for providing the computer program product 1 to the computer 3, any suitable carrier medium can be used such as a CD-ROM, tape device, or solid state memory device. Also in FIG. 1 the network 5 can comprise any type of network such as a wireless network (either terrestrial or satellite-based) or a wire network such as a telecommunications network.

FIG. 2 is a schematic diagram of the architecture of the computer 3 once the computer program product 1 has been installed therein.

The computer comprises a network connection 10, e.g. a modem or Ethernet card. A data and address bus 17 is provided for interconnecting components within the computer. A disk drive 18 is provided connected to the bus 17 for the receipt of the floppy disk 2. A pointing device 13, e.g. a mouse is connected to the bus 17 to allow for user input. A display 11 is provided connected to the bus to provide the display for the user interface. A keyboard 12 is provided connected to the bus 17 to allow user keyboard input. A program memory 15 is provided for storing code which is implemented by the processor 14 in the computer 3. The program memory stores code which is read and implemented by the processor 14. The processor 14 reads operating system code for the program memory 15 in order to implement an operating system 14a. The control application code is read from the program 15 in order to implement a control application process 14b. The three other processes 14c, 14d and 14e are implemented by the processor 14 by reading code from program memory 15 and implementing the code. The program memory 15 comprises either volatile or none volatile storage. During implementation of the control process, the program memory 15 comprises volatile memory. The program memory 15 however can also comprise non-volatile memory, e.g. a hard disk drive, for the storage of the code when not being implemented by the processor 14.

A data memory 16 is provided connected to the bus 17 for the storage of data to be used by the control process application 14b. The data memory stores three files. A file containing a list of allowed processes, a file containing a list of disallowed processes and a file containing configuration data. When the control process is first executed in the computer, the list of allowed processes and disallowed processes will be empty and will need to be populated. As will be described in more detail hereinafter, this can be achieved during the first execution of the process by copying the process list. The lists of allowed and disallowed processes can thereafter be modified by a user using the user interface. The data memory 16 can comprise volatile or non-volatile memory. During execution of the control process 14b, the control process 14b can read and write data to and from the files as necessary. For example, where modifications to the allowed and disallowed lists are made, e.g. by user selections, the data in the files is modified accordingly.

The operation of the control process will now be described with reference to the flow diagram of FIGS. 3a and 3b. The process illustrated in FIGS. 3a and 3b contains all of the possible user selection options. The second to fifth embodiments described hereinafter describe variations in the user selection options.

When the computer boots up (step S1) the control application is loaded and runs as the control process on start-up (step S2). The control process comprises a thread of commands which are entered into the process queue. For illustrated purposed, in this embodiment of the present invention, the control process 14b is loaded with three other processes 14c, 14d and 14e (FIG. 2) thus the process queue 100 illustrated in FIG. 4 comprises an interlaced set of commands comprising, for example, command 1A, 1B and 1C for process 1, command 2A and 2B for process 2, command 3A and 3B for process 3 and the register command 4 and command 4A for the control process

FIG. 4 illustrates the relationship of the processor queue 100 to the process list 101 maintained by the operating system 14A. In this embodiment of the present invention, the operating system comprises a Windows (trade mark) operating system, e.g. Windows 95, Windows 98, Windows 2000, Windows NT, or Windows XP. As can be seen in FIG. 4, processes 1, 2 and 3 are already registered in the process list 101. The commands for implementing the threads of the processes 1, 2 and 3 have been entered into the process queue 100. The control process includes a register command 4 followed by other commands (only the first command 4A illustrated in FIG. 4). The register command is the first command implemented by the process and this command causes the process to be added to the process list 101 by the operating system. The process list stores various information regarding the process including the file name and path. The order in which the commands are placed in the process queue 100 is dependent upon the priority assigned to them by the operating system or by the application.

Thus, as can be seen in FIG. 4, when the register command is executed (step S3 in FIG. 3a) the control application is registered in the process list 101 (step S4 in FIG. 3a). Thus the queue of commands for the thread for the control process is executed (step S6) and the next command that is implemented in the thread (command 4A) is the command to delete the control application from the process list (step S7). Thus in this way the control process is hidden and cannot be terminated by, for example, using the CONTROL-ALT-DELETE keys to halt a process under the Windows operating system. The CONTROL-ALT-DELETE function under Windows allows access to the process list and allows processes in the list to be terminated.

As an alternative to the execution of the process in which the process is registered in the process list 101 and then deleted, the process can instead in step S2 be executed as a service under Windows in the sane way as conventional virus-checking software, thereby avoiding the registration of the process in the process list 101: services are not registered as processes in the process list 101 and cannot be terminated.

The thread of the control process will thus execute in the process queue 100. The next command executed in the thread is a command to copy the current process list to a reference list in the memory (step S8). The control process therefore has a list of all processes that are being implemented on start-up. This is used as a base reference to identify any new processes which are subsequently executed which may or may not be allowed.

So far steps S1 to S8 described hereinabove comprise the initiation phase in which the control application is loaded and the instance of the control application, i.e. the control process is configured to start monitoring and controlling processes. The monitoring is performed cyclically and thus the process waits for a predetermined period (in this case 10 ms) since a previous comparison (step S9) before comparing the cost process list to the reference list stored in memory (step S10). In this way any difference (step S11) can be determined between the current process list and the reference process list. If there is no difference, the process returns to await the next cycle of the monitoring (step S9). The comparison between the process list and the reference list can comprise a simple binary comparison of the code stored for the reference list and the code stored for the process list. Any difference will need to be considered by the control process. If there is a difference (step S1) the content of the process list will need to be read to identify the process or processes that are different, i.e. were loaded subsequent to start-up. The file name and file path is available from the content of the process list. Other information on the process can be obtained from the operating system such as file size, version number, creation date, or any other distinctive or distinguishing parameters. Identifying features for the process can be compared with identifying features for allowed processes in the allowed process list stored in the allowed processes file. For example, the file name and path can be used. However, to avoid the security of the system being circumvented simply by the name of an application being changed, file size and/or version number can also be used to compare known allowed processes identified by information in the allowed processes list with information obtained for the new processes. If it is determined that the process identified is properly identified in the allowed processes list, the process is allowed to run (step S13). If the processes are not identified as being in the allowed list, they are compared with the disallowed list (step S14). If the process is identified as being disallowed (step S14) a user interface window is generated to warn the user that a disallowed process is trying to run and the user can select whether to kill the process or allow it to run (step S15). The command in the thread of the control process which generates the user interface (step S15) prevents the further processing of other processes until the user makes their selection. This ensures that the process cannot continue unless the user selects to allow it. If a user selects to kill the process, in step S16 the control process generates a kill process command which is added to the process queue with a high priority to delete the process from the process list. The process then returns to await the next cycle (step S9).

If the process is neither in the allowed list (step S12) or in the disallowed list (step S14) it is an unknown process and a user interface is displayed to allow a user to select whether or not to allow this unknown process to continue (step S17). If a user selects to allow the process (step S17) the user can be provided with the option to remember their selection. If they do select to remember their selection (step S18) the allowed process list is updated (step S19) and the process is allowed to execute (step S13). If a user selects not to remember the selection, the process list is not updated but the process is allowed to run (step S13). Thus a use can select to allow the previously unknown process simply on a one-time basis or to allow for all future executions of the process by adding it to the process list.

If the use selects not to allow the process (step S17) the user can select whether or not to remember the selection (step S20) if the user selects to remember the selection the disallowed process list is updated (step S21) otherwise no change is made to the disallowed process list. The control process then generates a kill process command which is added to the process queue with a high priority to kill the process and delete it from the process list (step S22). The control process can also be configured to display a warning (step S23) that the process has been killed indicating which process has been killed and to allow the user to select whether to allow the process next time (step S24). If a user selects to allow the process next time, the allowed process list is updated (step S25) and the process returns to await the next cycle, otherwise the next cycle is awaited. The option of warning a user that a process has been killed in this embodiment of the present invention is really superfluous since the user has already selected whether or not to allow the process (step S17). However, this embodiment displays all of three options given to a user (step S17, step S15 and step S24) with regard to selecting to allow processes to run. None or any combination of these selections can be made available by configuring the control process as will be described in more detail hereinafter.

FIG. 5 is a second embodiment of the present invention in which steps S1A to S13A correspond to steps S1 to S13 in the first embodiment of the present invention described with reference to FIGS. 3a and 3b. This embodiment differs, however, in that the control process has been configured to give no prompts to a user to allow the user to select to allow a process to run. In this embodiment if it is detected in step S12A that the process executed after start-up is not an allowed process in step S30 the control process generates a kill process command which is added with high priority to the queue to kill the process and delete it from the process list. The process then will return to await the next cycle (step S9A). Thus in accordance with this embodiment of the present invention, it is possible for a user to keep an allowed list of processes up to date whereby if a process is not in the allowed list, it will not be allowed to run and no manual override is provided for.

The user interface which allows a user to select which type of prompts to proceed is illustrated in FIG. 10. The interface of FIG. 10 shows the list of allows processes and the list of disallowed processes. The user can interact with the interface to add and delete processes from the allowed and disallowed lists. The user can also select to check any number of three checkboxes to select types of prompts. In the first embodiment of the present invention described with reference to FIGS. 3a and 3b, all of the checkboxes were selected. In the second embodiment of the present invention described with reference to the flow diagram of FIG. 5, none of the checkboxes were checked.

FIG. 10 illustrates the situation when a user has selected to receive a prompt when any new process starts to run. The operation when this selection is made will now be described with reference to the flow diagram of FIG. 6 which is a partial flow diagram following on from the flow diagram of FIG. 3a of the first embodiment of the present invention. Once a user has configured the control application in accordance with the selection illustrated in FIG. 10, the interface illustrated in FIG. 10 can be closed. The control process will then operate to monitor and control the processes in accordance with the configuration. This embodiment of the present invention is illustrated with reference to the execution of the calculator application in the Windows operating system. With the control process being executed, when a user attempts to execute the calculator application, as can be seen in FIG. 10, the calculator application is neither in the allowed list or in the disallowed list and thus a user interface is displayed, i.e. a window (step S17A) to allow a user to select whether or not to allow the calculator application to run. In this example, as illustrated in FIG. 10, a user selects to remember the answer and selects to allow the calculator application to run. Thus, steps S18 and S19A are executed and the result is illustrated FIG. 12 whereby the calculator application executes and the allowed list is updated to include the calculator application identified by its file name and version number.

A fourth embodiment of the present invention will now be described with reference to the flow diagram of FIG. 7 and the interfaces illustrated in FIGS. 13 and 14. In this embodiment of the present invention the user has used the interface illustrated in FIG. 13 to add the calculator application to the disallowed list and to select to receive a prompt to kill a new disallowed process. Thus when the user attempts to run the calculator application, it is detected by the control application that this is a disallowed process (step S14A) and as illustrated in FIG. 14 a user interface, i.e. a window, is displayed to allow a user to select whether or not to kill the calculator process (step S15A). If the user selects to kill the process the process will be killed (step S16A) and if the user selects not to kill the process, the calculator process will be allowed to run.

A fifth embodiment of the present invention will now be described with reference to the flow diagram of FIG. 8 and the user interfaces of FIGS. 15 to 17. In this example the user has selected to receive a prompt after any new process has been killed as illustrated in FIG. 15. Thus when the user attempts to execute the calculator application, it is detected that this is not an allowed process, neither is it a disallowed process (step S14A) but the process is killed (step S22A). A user warning is then displayed (step S23A) as illustrated in FIG. 16 to warn that the calculator process has been killed. A user is given an option to select to allow the application to run next time (step S24A). In this example the user elects to allow the calculator application next time (step S24A) and the calculator application information is added to the allowed process list (step S25A) as illustrated in the interface illustrated in FIG. 17. Thus when the calculator application runs next time, it will be allowed to execute.

The third and fifth embodiments of the present invention described hereinabove with reference to FIGS. 6 and 8 are particularly useful for allowing a user to select to allow unknown processes, i.e. processes which do not appear in the disallowed or the allowed lists. A user, or an administrator can set up the lists such that by default processes in the allowed list are allowed to run and processes in the disallowed list are not allowed to run. However new processes are either killed on their first execution attempt (the fifth embodiment) and a user is given a chance to allow the process next time, or a user is allowed to select to let the new application run (the third embodiment). The provision of user interfaces allowing user selections of processes to be allowed provides for a great deal of flexibility and manual control to accompany and supplement the automatic process control provided by the control process.

FIG. 10 is a flow diagram illustrating the process of control from the point of view of a process being controlled. When a new process starts (step S40) it registers as a new process in the process list (step S41). The control application then detects the fact that a new process has been added to the process list and will determine whether or not to kill the process (step S42). If the process is to be killed, the process is halted (step S44). If the process is to be allowed to execute, the next queued command is allowed to be executed (step S43).

In the embodiments of the present invention described hereinabove, the control application is configurable by selecting to open the control process management interface. The interface illustrated in FIGS. 10 to 17 illustrate the defaults view in the management interface. The defaults view as, for example, illustrated in FIG. 17 allows for the process lists, i.e. the allowed process and disallowed process lists to be modified. It also allows processes to be deleted manually. Further, the user prompts can be selected as described hereinabove. A second interface provided by the management interface is the options interface which provides for selection of configuration options. A password can be selected to restrict access to configuration of the control process. The timer interval for the cyclical timing of the monitoring and control process can be set. The kill process button in the general interface which will be described hereinafter with reference to FIG. 19 can also be selected to be hidden and not available to users. In this embodiment of the present invention, it is also possible to select the parameter to be used for the comparison between processes. It is possible to select to check the version number and the size, although in this embodiment only the version number is used in the comparison of identified processes with processes in the allowed and disallowed lists.

The management interface also provides a general interface as illustrated in FIG. 19. The general interface lists all of the processes currently being executed by the processor together with their full path and file name. A kill process button is provided to allow a process to be selected and killed. Although as described hereinabove, it is possible using the options management interface to disable or hide this kill process button.

In one embodiment of the present invention, the control process is managed by an administrator. A user of the computer is only provided with the interface illustrated in FIG. 19. An administrator uses a password to obtain access to the defaults and options interfaces for the configuration of the control process. This allows an administrator to control the processes that are in the allowed and disallowed lists and coutrols the level of flexibility with regard to the processes that can be run which is given to the user since the administrator can control the type of prompts given to the user. Thus this type of control is extremely useful for management purposes.

Another embodiment of the present invention is particularly suited to virus protection in which the control process is configured to operate in accordance with a third or fifth embodiment of the present invention. The fifth embodiment of the present invention is particularly suited to virus protection since it will kill any new process when it is first executed and it requires a user to specifically allow that process in the future. This will allow the process control to halt the execution of a virus on a computer and if a user does not recognize the process they will not select to allow the process next time, thereby blocking the virus. This process will not detect all types of viruses, e.g. it will not detect boot sector viruses or macro viruses. It will, however, detect any executable virus and these can be automatically blocked as illustrated in FIG. 5. Since the process will automatically block all new applications, it is a user-friendly requirement to allow the user to select a new process, e.g. when they install a new application which they wish to run on their computer.

In another embodiment of the present invention, the stored information on the processes includes information on when at least one process is to be allowed or disallowed. In this embodiment the allowed processes file and/or the disallowed processes file can additionally include a start time, day and/or date and an end time, day, and/or date for any process listed in the files. This information can therefore be additionally used during the decision steps of S12 and S14 to determine whether a process is allowed or disallowed to be executed. During the decision process, the current time, day, and/or date is determined from a system clock present in the computer and this is compared to the start and end time, day, and/or date. For example, if the additional information for a disallowed process indicates that the process is disallowed between the hours of 6pm and 8.30am, if a user of the computer attempts to run the process the decision process in step S14 leads to step S15. This example could for example apply to an office application which would not normally be required out of office hours. In another example, if the additional information for an allowed process indicates that the process is allowed to be executed between the hours of 6pm and 8.30am, if a user tried to run the process at 7pm in the decision step S12 the process would be allowed (step S13) but if they tried to run the process at 5pm, the decision step S14 would be applied. This example is applicable to web browsing in an office, where it has been decided to allow office staff access the web only outside office hours.

In a further embodiment of the present invention, the stored information can also include information indicating the number of times processes can be executed and a record of how many times the process has been executed. Thus in this embodiment of the present invention, there is automatic control of the number of times a process is run and a user can manually over ride this control. The control is provided as part of the decision steps S12 and S14. In this embodiment the allowed process file can additionally include information identifying the number of times a process is allowed to run and a record of the number of the process has been executed. Thus in the decision process it is simply necessary to compare these two parameters to see whether the process in the allowed list is to be allowed to execute. If the process is allowed to execute, the record of the number of times the process has been executed in the allowed processes file is updated (incremented).

In a further embodiment of the present invention, information on the processes being executed by the processing system is recorded. This information can include a record of the processes and the operations they performed, and screen shots. The recording of this information can be triggered when any new process executes and possibly periodically thereafter or when any change in executed processes is detected (step S11). The record can be stored locally on the computer or it can be transmitted to a network administrator for remote monitoring or management.

Another embodiment of the present invention provides for network management. In this embodiment the computer is networked to a network manager's computer and the information on the processes is stored on the central network manager's computer. The information can be accessed and read over the network by the computer to provide the process control. The network manager or administrator can be provided with access to the information for a number of networked computers e.g. as a database. This enables a network administrator to monitor and change the information. Further, the information for each process can be set access privileges to control the level of manual over ride control available to a local use. For example, information for a disallowed process could be flagged as network administrator changeable only, thereby preventing a user from changing the process to an allowable process or possibly even from manually over riding the automatic process control to allow the process on an ad hoc basis i.e. barring the user from not killing the process (i.e. selecting no in step S15). Thus this embodiment allows a network administrator to control the level of manual process control given to local users.

Although the present invention has been described hereinabove with reference to specific embodiments, it will be apparently to a skilled person in the art that modification lie within the spirit and scope of the present invention. Any aspect, embodiment, or means of the present invention can be used in combination with any the aspect of means.

1. A method of controlling processes executed by one or more processors in a processing system, comprising
identifying any processes being executed by the or each processor;
comparing any identified processes with stored information on one or more processes;
generating a user interface in dependence upon the comparison to allow a user to input a user selection to allow or disallow the execution of the process; and
controlling the execution of the processes by the or each processor in dependence upon the outcome of the comparison and the input user selection.

2. A method according to claim 1, wherein the processing system executes a multi-tasking operating system which maintains a process list, the processes being executed by the or each processor being identified from the process list.

3. A method according to claim 1, wherein the process identification, comparison and control is carried out repeatedly.

4. A method according to claim 3, wherein the periodicity of repetition of the process identification, comparison and control is selectable.

5. A method according to claim 1, wherein the method is implemented by executing processor code in the processing system thereby running a process during a boot up procedure.

6. A method according to claim 5, wherein during the boot up procedure the processes being executed by the or each processor are identified and stored as said stored information on processes.

7. A method according to claim 6, wherein the processing system implements a multi-tasking operating system which maintains a process list, the processes executed by the or each processor being identified from the process list.

8. A method according to claim 1, wherein said stored information on processes includes information obtained from user input selections identifying processes.

9. A method according to claim 5, wherein said process running as a result of loading of said processing code is hidden, and not included in the identified processes.

10. A method according to claim 7, including deleting an entry in the processing list for said process executing as a result of the loading of said processing code for implementing the method.

11. A method according to claim 2, wherein the method is implemented by executing processor code in the processing system thereby running a process during a boot up procedure, and during the boot up procedure the processes executed by the or each processor are identified from the process list and stored as said stored information on processes.

12. A method according to claim 2, wherein the method is implemented by executing processor code in the processing system as a service which does not appear in the process list.

13. A method according to claim 1, wherein the control of the process includes halting the execution of the process.

14. A method according to claim 1, wherein said information includes information on one or more processes which is to be allowed to be executed by the or each processor; the comparison determines if there are any identified processes which are not identified as being allowed to be executed; and if it is determined that there is one or more identified processes that are not identified as being allowed to be executed, the execution of the or each process is halted unless the input user selection is to allow the or each process to execute.

15. A method according to claim 1, wherein said information comprises information on one or more processes which is not to be allowed to be executed by the or each processor; the comparison determines if there are any identified processes which are identified as not being allowed to be executed; and if it is determined that there is one or more identified processes that are identified as not being allowed to be executed, the execution of the or each process is halted unless the input user selection is to allow the or each process to execute.

16. A method according to claim 1, wherein said stored information includes information on one or more processes which is to be allowed to be executed by the or each processor; the comparison determines if there are any identified processes which are not identified as being allowed to be executed; and the user interface is generated if it is determined that there is an identified process that is not identified as being allowed to be executed.

17. A method according to claim 16, wherein said stored information includes information on one or more processes which is not to be allowed to be executed by the or each processor; the comparison includes comparing any identified processes with said stored information to determine if there are any identified processes which are identified as not being allowed to be executed; and the control of the execution of the processes includes halting the execution of any process which is identified as not being allowed to be executed without generating a user interface for any identified processes which are identified as not being allowed to be executed.

18. A method according to claim 16, including adding information identifying the process allowed to be executed to said stored information.

19. A method according to claim 18, wherein the adding of the information to the stored information is dependent on receiving a user input.

20. A method according to claim 17, including adding information identifying the process not to be allowed to be executed to said stored information.

21. A method according to claim 20, wherein the adding of the information to the stored information is dependent on receiving a user input.

22. A method according to claim 1, wherein said stored information on one or more processes not to be allowed to be executed by the or each processor; the comparison determines if there are any identified processes which are identified as not being allowed to be executed; and if it is determined that there is an identified process that is identified as not being allowed to be executed, the user interface is generated indicating that the process is disallowed to allow a user to input a user selection to allow or disallow the execution of the identified process.

23. A method according to claim 22, wherein said stored information includes information on processes to be allowed to be executed by the or each processor; the comparison includes comparing any identified processes with said stored information to determine if there are any identified processes which are identified as being allowed to be executed; and if it is determined that there is an identified process that is identified as being allowed to be executed, the control of the execution of the identified process allows the execution of the process.

24. A method according to claim 1, wherein said stored information includes information on processes not to be allowed to be executed by the or each processor; the comparison includes comparing any identified processes with said stored information to determine if there are any identified processes which are identified as not being allowed to be executed; and if it is determined that there is an identified process that is identified as not being allowed to be executed, the execution of the process is halted, the user interface is generated to allow a user to input a user selection to allow or disallow the execution of the identified process next time, and information identifying the process to be allowed to be executed is added to said stored information if the input user selection is to allow the process next time.

25. A method according to claim 24, wherein said stored information includes information on processes to be allowed to be executed by the or each processor; the comparison includes comparing any identified processes with said stored information to determine if there are any identified processes which are identified as being allowed to be executed; and if it is determined that there is an identified process that is identified as being allowed to be executed, the execution of the identified process is allowed.

26. A method according claim 1, wherein the stored information includes for each process at least one of file name and path, file size, version number, and date of creation of the application file of which the process is an instance; the process identification comprises determining for each identified process at least one of file name and path, file size, version number, and date of creation of the application file of which the process is an instance; and the comparison comprises comparing at least one of file name and path, file size, version number, and date of creation for the identified process with at least one of file name and path, file size, version number, and date of creation for the or each process in said stored information.

27. A method according to claim 1, including providing an interface to allow the input of selections of one or more processes to be allowed and/or disallowed, and modifying said stored information to include information on the or each selected process.

28. A method according to claim 27, wherein said interface is generated to require a password to allow the input of selections.

29. A method according to claim 1, wherein said stored information includes information on when at least one of the processes is allowed or disallowed to be executed, and the comparison of any identified processes with the stored information includes determining the current date and/or time for use in the comparison with said stored information.

30. A method according to claim 1, wherein said stored information includes information on the number of times a process has been executed and information on the number of times a process is allowed to be executed, the comparison of any identified processes with the stored information includes comparing the information on the number of times the process is allowed to be executed with the information on the number of times the process has executed, the user interface is generated if the number of times a process has been executed equals the number of times the process is allowed to be executed to allow a user to input a user selection to allow or disallow the execution of the process, the execution of the process is controlled in dependence upon the outcome of the comparison and the input user selection, and the information on the number of times the process has been executed in said stored information is updated if the process is allowed to be executed.

31. A method according to claim 1, wherein the processing system is connected by a communications network to management processing apparatus, the stored information on one or more processes is stored at the management processing apparatus, and the comparison of any identified processes with the stored information includes reading the stored information at the management processing apparatus over the communications network.

32. A method according to claim 31, wherein said stored information includes identifiers for the or each process to identify whether the process can be allowed or disallowed by an input from a user of the processing system or whether the process can only be allowed or disallowed by an input from an operator of the management processing system.

33. A method according to claim 32, wherein the generation of the user interface is dependant upon the identifier for the process in said stored information.

34. A method according to claim 1, including determining information on processes being executed and storing the information.

35. A method according to claim 34, wherein the determination of information on processes takes place when it is determined that there is a change in the processes being executed.

36. A method according to claim 34, wherein the information is transmitted to a management processing system.

37. A controlled processing system, comprising:
at least one processor;
storing means for storing information on one or more processes;
identifying means for identifying processes being executed by the or each processor;
comparing means for comparing identified processes with said stored information;
generating means for generating a user interface to allow a user to input a user selection to allow or disallow the execution of the process; and
controlling means for controlling the execution of the processes by the or each processor in dependence upon the outcome of the comparison and the input user selection.

38. A controlled processing system according to claim 37, including a multi-tasking operating system for maintaining a process list, wherein said identifying means is adapted to identify the processes being executed by the or each processor from the process list.

39. A controlled processing system according to claim 37, wherein said identifying means, said comparing means and said controlling means are adapted to carry out the identification, comparison, and control repeatedly.

40. A controlled processing system according to claim 39, including periodicity selection means for selecting a periodicity of repetition of the identification, comparison, and control by said identifying means, said comparing means and said controlling means, wherein said identifying means, said comparing means and said controlling means are adapted to carry out the identification, comparison, and control with the periodicity selected by said selection means.

41. A controlled processing system according to claim 37, wherein said identifying means, said comparing means and said controlling means comprise processor code executed in the processing system to run a process during a boot up procedure.

42. A controlled processing system according to claim 41, wherein said processing code is adapted to, during the boot up procedure, identify and store the processes being executed by the or each processor as said stored information on processes in said storing means.

43. A controlled processing system according to claim 42, including a multi-tasking operating system for maintaining a process list, said identifying means being adapted to identify the processes executed by the or each processor from the process list.

44. A controlled processing system according to claim 37, wherein said storing means stores information obtained from user input selections identifying processes.

45. A controlled processing system according to claim 41, wherein said processing code is adapted to execute as a hidden process not included in the identified processes.

46. A controlled processing system according to claim 45, wherein said processing c code is adapted to delete an entry in the processing list for said process executing as a result of the loading.

47. A controlled processing system according to claim 38, wherein said identifying means, said comparing means and said controlling means comprise processor code executed in the processing system to run a process during a boot up procedure and to, during the boot up procedure, identify and store the processes being executed by the or each processor as said stored information on processes in said storing means.

48. A controlled processing system according to claim 38, wherein said comparing means and said controlling means comprise processor code executed in the processing system as a service which does not appear in the process list.

49. A controlled processing system according to claim 37, wherein said control means is adapted to include as a method of control of the process, halting the execution of the process.

50. A controlled processing system according to claim 37, wherein said storing means stores information on one or more processes which is to be allowed to be executed by the or each processor; said comparing means is adapted to determine if there are any identified processes which are not identified as being allowed to be executed; and said control means is adapted to, if it is determined that there is one or more identified processes that are not identified as being allowed to be executed, halt the execution of the or each process unless the input user selection is to allow the execution of the or each process.

51. A controlled processing system according to claim 37, wherein said storing means stores information on one or more processes which is not to be allowed to be executed by the or each processor; said comparing means is adapted to determine if there are any identified processes which are identified as not being allowed to be executed; and said controlling means is adapted to, if it is determined that there is one or more identified processes that are identified as not being allowed to be executed, halt the execution of the or each process unless the input user selection is to allow the execution of the or each process.

52. A controlled processing system according to claim 37, wherein said storing means stores information on one or more processes which is to be allowed to be executed by the or each processor; said comparing means is adapted to determine if there are any identified processes which are not identified as being allowed to be executed; wherein said user interface generating means is adapted to generate the user interface if it is determined that there is an identified process that is not identified as being allowed to be executed.

53. A controlled processing system according to claim 52, wherein said storing means stores information on one or more processes which is not to be allowed to be executed by the or each processor; said comparing means is adapted to comparing any identified processes with said stored information to determine if there are any identified processes which are identified as not being allowed to be executed; said control means is adapted to control the execution of the processes by halting the execution of any process which is identified as not being allowed to be executed; and said user interface generating means is adapted not to generate a user interface for any identified processes which are identified as not being allowed to be executed.

54. A controlled processing system according to claim 52, including adding means for adding information identifying the process allowed to be executed to said stored information in said storing means.

55. A controlled processing system according to claim 54, wherein said adding means is adapted to add the information to the stored information dependent on receiving a user input.

56. A controlled processing system according to claim 55, including adding means for adding information identifying the process not to be allowed to be executed to said stored information in said storing means.

57. A controlled processing system according to claim 56, wherein said adding means is adapted to add the information to the stored information dependent on receiving a user input.

58. A controlled processing system according to claim 37, wherein said storing means stores information on one or more processes not to be allowed to be executed by the or each processor; said comparing means is adapted to determine if there are any identified processes which are identified as not being allowed to be executed; wherein said user interface generating means is adapted to generate the user interface if it is determined that there is an identified process that is identified as not being allowed to be executed.

59. A controlled processing system according to claim 58, wherein said storing means stores information on processes to be allowed to be executed by the or each processor; said comparing means includes comparing any identified processes with said stored information to determine if there are any identified processes which are identified as being allowed to be executed; and said control means is adapted to, if it is determined that there is an identified process that is identified as being allowed to be executed, control the execution of the identified process to allow the execution of the process.

60. A controlled processing system according to claim 37, wherein said storing means stores information on processes not to be allowed to be executed by the or each processor: said comparing means is adapted to compare any identified processes with said stored information to determine if there are any identified processes which are identified as not being allowed to be executed; and said control means is adapted to, if it is determined that there is an identified process that is identified as not being allowed to be executed, halt the execution of the process; wherein said user interface generating means is adapted to generate the user interface to allow a user to input a user selection to allow or disallow the execution of the identified process next time; and including adding means for adding information identifying the process to be allowed to be executed to said stored information in said storing means if the input user selection is to allow the process next time.

61. A controlled processing system according to claim 60, wherein said storing means stores information on processes to be allowed to be executed by the processor; said comparing means is adapted to compare any identified processes with said stored information to determine if there are any identified processes which are identified as being allowed to be executed; and said controlling means is adapted to, if it is determined that there is an identified process that is identified as being allowed to be executed, allow the execution of the identified process.

62. A controlled processing system according to claim 37, wherein said storing means stores for each process at least one of file name and path, file size, version number, and date of creation of the application file of which the process is an instance; said identifying means is adapted to determine for each identified process at least one of file name and path, file size, version number, and date of creation of the application file of which the process is an instance; and said comparing means is adapted to compare at least one of file name and path, file size, version number, and date of creation for the identified process with at least one of file name and path, file size, version number, and date of creation for the or each process in said stored information.

63. A controlled processing system according to claim 37, including interface generating means for generating an interface to allow the input of selections of one or more processes to be allowed and/or disallowed, and modifying means for modifying said stored information to include information on the or each selected process.

64. A controlled processing system according to claim 63, wherein said interface generating means is adapted to generate the interface to require a password to allow the input of selections.

65. A controlled processing system according to claim 37, wherein said storing means is adapted to store said stored information to include information on when at least one of the processes is allowed or disallowed to be executed, and said comparing means is adapted to determine the current date and/or time for use in the comparison with said stored information.

66. A controlled processing system according to claim 37, wherein said storing means is adapted to store said stored information to include information on the number of times a process has been executed and information on the number of times a process is allowed to be executed, said comparing means is adapted to compare the information on the number of times the process is allowed to be executed with the information on the number of times the process has executed, said generating means is adapted to generate the user interface if the number of times a process has been executed equals the number of times the process is allowed to be executed to allow a user to input a user selection to allow or disallow the execution of the process, and said storing means is adapted to update the information on the number of times the process has been executed in said stored information if the process is allowed to be executed.

67. A controlled processing system according to claim 37, including connection means for connecting the controlled processing system by a communications network to management processing apparatus, said storing means is adapted to store the stored information on one or more processes at the management processing apparatus, and said comparing means is adapted to read the stored information at the management processing apparatus over the communications network.

68. A controlled processing system according to claim 67, wherein said storing means is adapted to store the stored information to include identifiers for the or each process to identify whether the process can be allowed or disallowed by an input from a user of the processing system or whether the process can only be allowed or disallowed by an input from an operator of the management processing system.

69. A controlled processing system according to claim 68, wherein said generation means is adapted to generate the user interface dependant upon the identifier for the process in said stored information.

70. A controlled processing system according to claim 37, including process determining means for determining information on processes being executed and storing the information.

71. A controlled processing system according to claim 70, wherein said process determining means is adapted to determine information on processes when it is determined that there is a change in the processes being executed.

72. A controlled processing system according to claim 70, including information transmission means for transmitting the information to a management processing system.

73. A processing system comprising:
a program memory storing processor readable program code for implementation by at least one processor; and
at least one processor for reading and implementing the program code stored in said program memory;
wherein said program code includes instructions for controlling said at least one processor to carry out the method of any one of claims 1 to 36.

74. A program storage device readable by a machine, embodying a program of instructions executable by at least one processor in a processing system to perform the method steps of the method according to claim 1.

75. A method of controlling any processes executed by at least one processor in a processing system operating under the control of an operating system, the method comprising:
identifying any processes being executed by said at least one processor using a process list maintained by the operating system containing a list of currently executed processes;
comparing any identified processes with stored information on one or more processes; and
controlling the execution of the identified processes by said at least one processor in dependence upon the outcome of the comparison.

76. A method according to claim 75, wherein the method is implemented by executing processor code in the processing system thereby running a process during a boot up procedure, and during the boot up procedure the processes executed by the processor are identified from the process list and stored as said stored information on processes.

77. A method according to claim 76, including deleting an entry in the processing list for said process running as a result of the loading of said processing code for implementing the method.

78. A method according to claim 75, wherein the method is implemented by executing processor code in the processing system as a service which does not appear in the process list.

79. A carrier medium carrying processor readable instructions for execution by at least one processor to implement the method of claim 75.

80. A method of controlling at least one process executed by at least one processor in a processing system, the method comprising:
storing information on processes to be allowed to be executed by said at least one processor;
identifying any processes being executed by said at least one processor;
comparing any identified processes with said stored information to determine if there are any identified processes which are not identified as being allowed to be executed;
if it is determined that there is an identified process that is not identified as being allowed to be executed, generating a user interface to allow a user to input a user selection to allow or disallow the execution of the identified process; and
controlling the execution of the process by said at least one processor in dependence upon the input user selection.

81. A method according to claim 80, including adding information identifying the process allowed to be executed to said stored information.

82. A method according to claim 81, wherein the adding of the information to the stored information is dependent on receiving a user input.

83. A method according to claim 80, including storing information on processes not to be allowed to be executed by said at least one processor, comparing any identified processes with said stored information to determine if there are any identified processes which are identified as not being allowed to be executed and halting the execution of any process which is identified as not being allowed to be executed without generating a user interface for any identified processes which are identified as not being allowed to be executed.

84. A method according to claim 83, including adding information identifying the process not to be allowed to be executed to said stored information.

85. A method according to claim 84, wherein the adding of the information to the stored information is dependent on receiving a user input.

86. A method according to claim 80, wherein said stored information includes information on when at least one of the processes is allowed or disallowed to be executed, and the comparison of any identified processes with the stored information includes determining the current date and/or time for use in the comparison with said stored information.

87. A method according to claim 80, wherein said stored information includes information on the number of times a process has been executed and information on the number of times a process is allowed to be executed, the comparison of any identified processes with the stored information includes comparing the information on the number of times the process is allowed to be executed with the information on the number of times the process has executed, the user interface is generated if the number of times a process has been executed equals the number of times the process is allowed to be executed to allow a user to input a user selection to allow or disallow the execution of the process, the execution of the process is controlled in dependence upon the outcome of the comparison and the input user selection, and the information on the number of times the process has been executed in said stored information is updated if the process is allowed to be executed.

88. A method according to claim 80, wherein the processing system is connected by a communications network to management processing apparatus, the stored information on one or more processes is stored at the management processing apparatus, and the comparison of any identified processes with the stored information includes reading the stored information at the management processing apparatus over the communications network.

89. A method according to claim 88, wherein said stored information includes identifiers for the or each process to identify whether the process can be allowed or disallowed by an input from a user of the processing system or whether the process can only be allowed or disallowed by an input from an operator of the management processing system.

90. A method according to claim 89, wherein the generation of the user interface is dependant upon the identifier for the process in said stored information.

91. A method according to claim 80, including determining information on processes being executed and storing the information.

92. A method according to claim 91, wherein the determination of information on processes takes place when it is determined that there is a change in the processes being executed.

93. A method according to claim 91 or claim 92, wherein the information is transmitted to a management processing system.

94. A processing system comprising:
a program memory storing processor readable instructions;
at least one processor for reading and implementing the instructions in said program memory;
wherein said instructions comprise instructions for controlling said at least one processor to:
identify any processes being executed by said at least one processor;
compare any identified processes with stored information on processes to be allowed to be executed by said at least one processor to determine if there are any identified processes which are not identified as being allowed to be executed;
if it is determined that there is an identified process that is not identified as being allowed to be executed, generate a user interface to allow a user to input a user selection to allow or disallow the execution of the identified process; and
control the execution of the process by said at least one processor in dependence upon the input user selection.

95. A processing system according to claim 94, wherein said instructions comprise instructions for controlling said at least one processor to add information identifying the process allowed to be executed to said stored information.

96. A processing system according to claim 95, wherein said instructions comprise instructions for controlling said at least one processor to add the information to the stored information dependent on receiving a user input.

97. A processing system according to claim 94, wherein said data store stores information on processes not to be allowed to be executed by said at least one processor, and said instructions comprise instructions for controlling said at least one processor to compare any identified processes with said stored information to determine if there are any identified processes which are identified as not being allowed to be executed and to halt the execution of any process which is identified as not being allowed to be executed without generating a user interface for any identified processes which are identified as not being allowed to be executed.

98. A processing system according to claim 97, wherein said instructions comprise instructions for controlling said at least one processor to add information identifying the process not to be allowed to be executed to said stored information.

99. A processing system according to claim 98, wherein said instructions comprise instructions for controlling said at least one processor to add the information to the stored information dependent on receiving a user input.

100. A processing system according to claim 94, wherein said stored information includes information on when at least one of the processes is allowed or disallowed to be executed, and said instructions comprise instructions for controlling said at least one processor to determining the current date and/or time for use in the comparison with said stored information.

101. A processing system according to claim 94, wherein said stored information includes information on the number of times a process has been executed and information on the number of times a process is allowed to be executed, said instructions comprise instructions for controlling said at least one processor to compare the information on the number of times the process is allowed to be executed with the information on the number of times the process has executed, to generate the user interface if the number of times a process has been executed equals the number of times the process is allowed to be executed to allow a user to input a user selection to allow or disallow the execution of the process, and to update the information on the number of times the process has been executed in said stored information if the process is allowed to be executed.

102. A processing system according to claim 94, wherein the processing system includes a communications port for connection to a communications network to connect to management processing apparatus, the stored information on one or more processes is stored at the management processing apparatus, and said instructions comprise instructions for controlling said at least one processor to read the stored information at the management processing apparatus over the communications network.

103. A processing system according to claim 102, wherein said stored information includes identifiers for the or each process to identify whether the process can be allowed or disallowed by an input from a user of the processing system or whether the process can only be allowed or disallowed by an input from an operator of the management processing system.

104. A processing system according to claim 103, wherein said instructions comprise instructions for controlling said at least one processor to generate the user interface dependant upon the identifier for the process in said stored information.

105. A processing system according to claim 94, wherein said instructions comprise instructions for controlling said at least one processor to determine information on processes being executed and to store the information.

106. A processing system according to claim 105, wherein said instructions comprise instructions for controlling said at least one processor to determinate the information on processes when it is determined that there is a change in the processes being executed.

107. A processing system according to claim 105 or claim 106, wherein said instructions comprise instructions for controlling said at least one processor to transmit the information to a management processing system.

108. A program storage device readable by a machine, embodying a program of instructions executable by at least one processor in a processing system to perform the method steps of the method according to claim 80.

109. (canceled)

110. (canceled)

111. (canceled)

112. (canceled)

113. (canceled)

114. (canceled)

115. (canceled)

116. (canceled)

117. (canceled)

118. (canceled)

119. (canceled)

120. (canceled)

121. (canceled)

122. A method of controlling at least one process executed by at least one processor in a processing system, the method comprising:
storing information on processes not to be allowed to be executed by said at least one processor;
identifying processes being executed by said at least one processor;
comparing any identified processes with said stored information to determine if there are any identified processes which are identified as not being allowed to be executed;
if it is determined that there is an identified process that is identified as not being allowed to be executed, generating a user interface to allow a user to input a user selection to allow or disallow the execution of the identified process; and
controlling the execution of the process by said at least one processor in dependence upon the input user selection.

123. A method according to claim 122, including storing information on processes to be allowed to be executed by the processor; comparing any identified processes with said stored information to determine if there are any identified processes which are identified as being allowed to be executed; and if it is determined that there is an identified process that is identified as being allowed to be executed, allowing the execution of the identified process.

124. A method according to claim 122, wherein said stored information includes information on when at least one of the processes is allowed or disallowed to be executed, and the comparison of any identified processes with the stored information includes determining the current date and/or time for use in the comparison with said stored information.

125. A method according to claim 122, wherein said stored information includes information on the number of times a process has been executed and information on the number of times a process is allowed to be executed, the comparison of any identified processes with the stored information includes comparing the information on the number of times the process is allowed to be executed with the information on the number of times the process has executed, the user interface is generated if the number of times a process has been executed equals the number of times the process is allowed to be executed to allow a user to input a user selection to allow or disallow the execution of the process, the execution of the process is controlled in dependence upon the outcome of the comparison and the input user selection, and the information on the number of times the process has been executed in said stored information is updated if the process is allowed to be executed.

126. A processing system comprising:
a program memory storing processor readable instructions;
at least one processor for reading and implementing the instructions in said program memory;
wherein said instructions comprise instructions for controlling said at least one processor to:
identify any processes being executed by said at least one processor;
compare any identified processes with stored information on processes not to be allowed to be executed by said at least one processor to determine if there are any identified processes which are identified as not being allowed to be executed;
if it is determined that there is an identified process that is identified as not being allowed to be executed, generate a user interface to allow a user to input a user selection to allow or disallow the execution of the identified process; and control the execution of the process by said at least one processor in dependence upon the input user selection.

127. A processing system according to claim 126, wherein said stored information comprises information on processes to be allowed to be executed by the processor; and said instructions comprise instructions for controlling said at least one processor to compare any identified processes with said stored information to determine if there are any identified processes which are identified as being allowed to be executed, and if it is determined that there is an identified process that is identified as being allowed to be executed, to allow the execution of the identified process.

128. A processing system according to claim 126, wherein said stored information includes information on when at least one of the processes is allowed or disallowed to be executed, and said instructions comprise instructions for controlling said at least one processor to determining the current date and/or time for use in the comparison with said stored information.

129. A processing system according to claim 126, wherein said stored information includes information on the number of times a process has been executed and information on the number of times a process is allowed to be executed, and said instructions comprise instructions for controlling said at least one processor to compare the information on the number of times the process is allowed to be executed with the information on the number of times the process has executed, to generate the user interface if the number of times a process has been executed equals the number of times the process is allowed to be executed to allow a user to input a user selection to allow or disallow the execution of the process, and to update the information on the number of times the process has been executed in said stored information if the process is allowed to be executed.

130. A program storage device readable by a machine, embodying a program of instructions executable by at least one processor in a processing system to perform the method steps of the method according to claim 122.

131. (canceled)

132. (canceled)

133. (canceled)

134. A method of controlling at least one process executed by at least one processor in a processing system, the method comprising:
storing information on processes not to be allowed to be executed by said at least one processor;
identifying any processes being executed by said at least one processor;
comparing any identified processes with said stored information to determine if there are any identified processes which are identified as not being allowed to be executed; and
if it is determined that there is an identified process that is identified as not being allowed to be executed, halting the execution of the process, generating a user interface to allow a user to input a user selection to allow or disallow the execution of the identified process next time, and adding information identifying the process to be allowed to be executed to said stored information if the input user selection is to allow the process next time.

135. A method according to claim 134, including storing information on processes to be allowed to be executed by said at least one processor; comparing any identified processes with said stored information to determine if there are any identified processes which are identified as being allowed to be executed; and if it is determined that there is an identified process that is identified as being allowed to be executed, allowing the execution of the identified process.

136. A processing system comprising: a data store storing information on processes not to be allowed to be executed by said at least one processor;
a program memory storing processor readable instructions;
at least one processor for reading and implementing the instructions in said program memory;
wherein said instructions comprise instructions for controlling said at least one processor to:
identify any processes being executed by said at least one processor;
compare any identified processes with said stored information to determine if there are any identified processes which are identified as not being allowed to be executed; and
if it is determined that there is an identified process that is identified as not being allowed to be executed, halt the execution of the process, generate a user interface to allow a user to input a user selection to allow or disallow the execution of the identified process next time, and add information identifying the process to be allowed to be executed to said stored information if the input user selection is to allow the process next time.

137. A processing system according to claim 136, wherein said data store stores information on processes to be allowed to be executed by said at least one processor; and wherein said instructions comprise instructions for controlling said at least one processor to compare any identified processes with said stored information to determine if there are any identified processes which are identified as being allowed to be executed; and if it is determined that there is an identified process that is identified as being allowed to be executed, allow the execution of the identified process.

138. A program storage device readable by a machine, embodying a program of instructions executable by at least one processor in a processing system to perform the method steps of the method according to claim 134.

139. (canceled)

140. A method of controlling a process executed by one or more processors in a processing system, comprising
identifying a process being executed by the or each processor;
comparing any identified process with stored information on one or more processes;
generating a user interface in dependence upon the comparison to allow a user to input a user selection to allow or disallow the execution of the process; and
controlling the execution of the process by the or each processor in dependence upon the outcome of the comparison and the input user selection.

141. A controlled processing system, comprising:
at least one processor;
storing means for storing information on one or more processes;
identifying means for identifying a process being executed by the or each processor;
comparing means for comparing any identified process with said stored information;
generating means for generating a user interface to allow a user to input a user selection to allow or disallow the execution of the process; and
controlling means for controlling the execution of the process by the or each processor in dependence upon the outcome of the comparison and the input user selection.

142. A program storage device readable by a machine embodying a program of instructions executable by a computer to perform the method steps of the method of claim 140.
